(19) United States
(12) Patent Application Publication
(10) Pub. No.: US 2016/0358420 A1
(43) Pub. Date: Dec. 8, 2016

(54) Gaming Platform Method with backing of in-game resource by real world resource

(71) Applicants: Stephen McCullah, Ash Grove, MO (US); Kyle Hornback, Springfield, MO (US)

(72) Inventors: Stephen McCullah, Ash Grove, MO (US); Kyle Hornback, Springfield, MO (US)

(21) Appl. No.: 14/935,397

(22) Filed: Nov. 7, 2015

Related U.S. Application Data
(60) Provisional application No. 62/172,333, filed on Jun. 8, 2015.

(51) Int. Cl. G07F 17/32

(52) U.S. Cl. CPC G07F 17/3246; G07F 17/3255; G07F 17/3218; G07F 17/3276

(57) ABSTRACT

A method is disclosed wherein an in-game currency (including digital or crypto currency) or in-game resource is backed by or designated to represent a real world currency or a real world physical object. The in-game currency or in-game resource is backed with real currency (for example USD), digital currency (for example Bitcoin) or a physical object (like gold) using a percentage of the revenues from in-game purchases, game subscriptions or in-game advertising.

### CROSS-REFERENCE TO RELATED APPLICATIONS

62/172,333

### STATEMENT REGARDING FEDERALLY SPONSORED RESEARCH OR DEVELOPMENT

Not Applicable

REFERENCE TO SEQUENCE LISTING, A TABLE, OR A COMPUTER PROGRAM LISTING COMPACT DISK APPENDIX

Not Applicable

### FIELD OF THE INVENTION

This invention relates generally to a single or multi player gaming method and system which provides backing of an in-game currency or resource by real world currency or resource.

### BACKGROUND OF THE INVENTION

Games in the current market incorporating in-game resources or in-game currencies provide no method of creating any long term absolute real world value. The only value that these in-game resources or in-game currencies accumulate is created by demand, which correlates to the entertainment and or social value experienced by the player. This demand fades away as popularity diminishes leaving no residual value or revenue generated by the game.

The prior art in U.S. Pat. No. 8,827,799 to Brown discloses a social gaming platform where players perform game-specific tasks to generate an in-game currency. The in-game revenue owned by a player provides the player with a weighted vote in how the real world revenue is to be spent on real world activities. There is no direct relationship between the unit value of the in-game currency and the real world currency generated by the game. The relative values of currencies are not tied in the system described therein and so the unit or total value of the in-game currency cannot increase.

### SUMMARY OF THE INVENTION

An in-game currency and/or in-game resource is designated to represent, or become backed by, a real world currency such as the US dollar, EURO or other real world currency, or a digital currency such as bitcoin, or a physical object such as gold or other precious goods. The real world currency or physical object would be produced using a percentage of real world revenue from the game and grow as revenue increased.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic representation of one embodiment of a method for the backing of an in-game currency with a real world currency or goods.

### DETAILED DESCRIPTION OF THE INVENTION

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims may be formulated in this Application or of any further Application derived therefrom, to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new claims may be formulated to such features and/or combinations of such features during the prosecution of the present Application or of any further Application derived therefrom.

The present invention generally provides a method and game platform in which in-game currency or in-game resource generates a stable real world or outside of game value. Hitherto this has been lacking in the prior art.

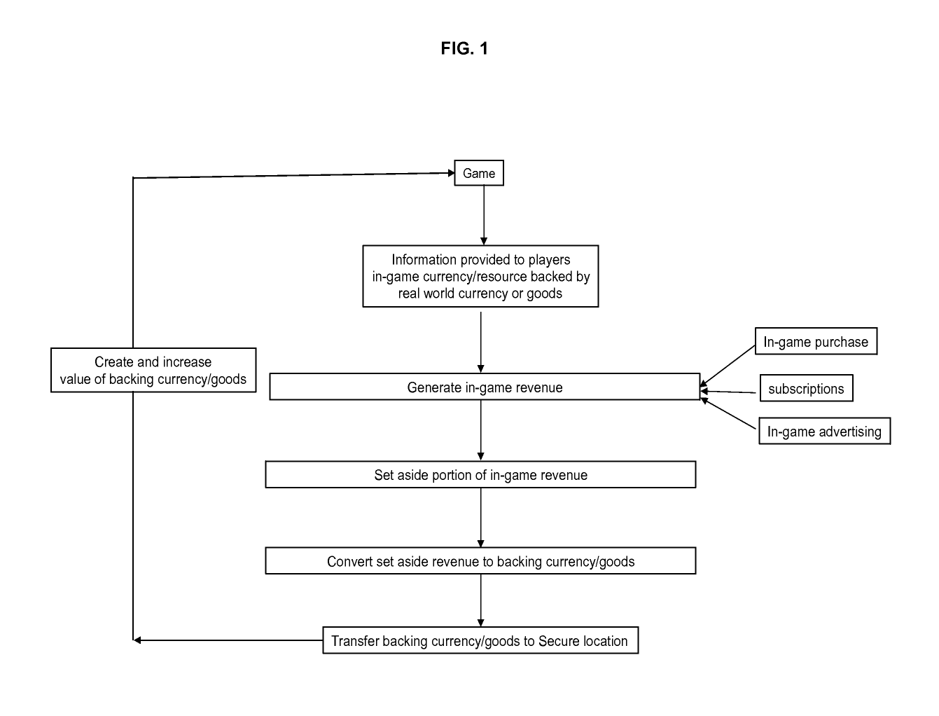

With reference to FIG. 1, the method of the general invention generates stable real world or outside of game value by taking revenue that comes in from in-game purchases, advertising, and game subscriptions and distributing a percentage to “back” an in-game resource or in-game currency with a physical object, or digital currency, or real world currency so that the in-game resource or in-game currency represents the physical object, digital currency, or real world currency. The in-game currency or in-game resource then continues to go up in value creating more of a demand and thus causing more players to make in-game purchases, which essentially raises the value even higher.

The term “to back” or “backing” is understood to mean wherein the in-game currency value directly corresponds with the value of a real world currency or physical object (such as gold), whether or not it is redeemable in that goods on demand.

In the present method an in-game currency or in-game resource is backed with real world currency or a physical object (like gold) using a percentage of the revenues from in-game purchases, game subscriptions or in-game advertising. Such an approach attracts further players into the game, thus creating more of a demand which in effect raises the value and then creates more demand. This cycle continues. Unlike the in-game currencies and in-game resources of other games which have a value driven by demand.

It is understood that the invention can be applied across a variety of game scenarios and situations such as, but not exclusively, video games, non-gambling video games, board games, simulations and a virtual economy. Game scenarios may involve one, two or more players, and one or more in-game currencies or goods, and one or more real world currencies or goods.

One embodiment of a method consistent with the general invention is includes the following features:
1. An in-game currency, such as digital or crypto currency, or in-game resource that is placed into or present within a game
2. A currency or resource is officially or unofficially backed by or designated to represent a real world currency or a real world physical object
3. Players, or users, of the game generate revenue from in-game purchases, pay subscription fees, and also income is generated by in-game advertising
4. A set percentage, which can range from about 1% to about 100%, preferably about 1% to about 50%, more preferably about 1% to about 10%, of income or revenue generated by the game is used to fund, or is deposited into, the group of real world currency or physical object(s) that back or is represent by the in-game resource or in-game currency

A method which includes features 1-4 enables the establishment and growth of a solid real world value to the in-game resource or in-game currency, this is achieved using a percentage of game revenue to officially or unofficially back the in-game resource or in-game currency.

A first feature of a method consistent with the general present invention is the provision of the in-game resource or in-game currency.

A second feature of a method provides information to players, subscribes, advertisers in form of a declaration, announcement or confirmation that the mentioned in-game resource or in-game currency is being backed. Without this feature the participants would not have knowledge that the in-game currency or in-game resource was backed, thus making the act of backing meaningless.

Furthermore the second feature, subsequent third and fourth features provide a promise to the players of the game, and outside entities, that an amount of revenue will be set aside in an account or secure location to only be used for the purpose of creating a solid value for the mentioned in-game resource or in-game currency.

The secure location may be electronic in nature such as bank account, online wallet, or fund, or the secure location can be physical in nature such as a room, safe or vault.

The third feature of the method provides in-game revenue, which is necessary as the in-game resources or in-game currency in step 1 would not grow in value and additional demand may not be created.

The real world currency or real world physical object set aside to back the in-game currency or in-game resource can always be offered as redeemable to the players collecting the in-game resource or in-game currency or anyone having obtained it.

If allowed, players or outside entities that have obtained the in-game resource or in-game currency would be able to exchange a set amount of in-game resource or in-game currency for the current value of the in-game resource or in-game currency as compared to real world currency, digital currency (such as bitcoin), or a real world physical object (such as gold).

Performing a method which includes each features 1-4 provides an in-game currency or in-game resource that has a growing real world value as well as a growing demand.

It is contemplated that a method with these features is suitable for any game that contains an in-game resource or in-game currency and enables the generation of revenue through in-game purchases, in-game advertising and subscriptions. Essential in-game features to this method are as follows; a currency or resource, players or users, a revenue stream, and a set percentage of revenue where from that revenue stream a percentage is being set aside to formally or informally back the currency or resource.

### EXAMPLE

A video game platform is provided where an in-game resource or in-game currency (possibly even a crypto or digital currency) can be generated or collected. This game possesses one or more features to generate revenue, such as in-game advertising, purchases pertaining to the game, or subscriptions to the game. A public declaration is made by the game platform and promise that a set, or unspecified, amount of revenue generated by the game will be placed in a secure location and left untouched. Optionally some or all of the revenue can be redeemed by players using the specified in-game currency or in-game resource in current real world currency form, another real world currency, or converted into a real world physical object, such as gold, for the purpose of backing the chosen in-game currency and/or in-game resources.

As revenue is generated in the video game by in-game advertising, purchases pertaining to the game, or subscriptions to the game, a set amount of revenue, is assigned to back the in-game currency or in-game resource and is transferred into a secure location where all other real world currency is located. The value of the set aside revenue is applied to all in-game currency or in-game resource that has been declared to have been backed. If, for example, the developers chose to back the in-game resource or in-game currency with a physical real world object, such as gold or silver or other precious goods, then all of the revenue assigned to back the in-game currency or in-game resource will be converted to the chosen physical real world object (such as gold or silver), placed in a secure location where all real world currency, real world physical objects, or a mix there of, are kept. The value, quantity, and/or weight of the total amount of real world currency and/or real world physical objects is determined. The determined total value is distributed to each unit of in-game resource or in-game currency that has been officially or unofficially declared as backed (or declared to represent it). The unit and total value is displayed to the public.

For example, if the in-game currency of the above video game stands at 10 million units and the weight of gold backing the in-game currency is determined to be 10 million ounces, then the value of the in-game currency is 1 ounce/unit. Clearly as further revenue generating activities are performed within the game, additional revenue is generated, and all or a portion of the revenue is converted to a backing real world currency/goods then the quantity of backing currency in the secure location increases as a result.

It is further contemplated that the backed in-game resource or in-game currency can be traded and so enabling player or players to receive the real world currency, or real world physical object that has been designated to back it, in return.

What is claimed:

1. A method based on a gaming system for backing in-game currency or resource with one or more real world currency or goods, the method comprising:
at least one in-game currency or resource,
providing information to players and other subscribers that the in-game currency or resource is to be backed,
receiving from the game, players or other subscribers revenue associated with the game from one or more of in-game purchases, game subscription fees and in-game advertising,
determining the in-game revenue,
transferring all or portion of the in-game revenue to a secure location in form of real world currency or goods backing the in-game currency or resource.

2. The method of claim 1, which further comprises determining the unit and total value of the in-game currency or resource from the real world currency or goods in the secure location.

3. The method of claim 1, wherein the game is a mobile phone or tablet app.

4. The method of claim 1, which optionally comprises allowing players to redeem all or a portion of the in-game currency or resource.

5. The method of claim 1, wherein the transferred portion of in-game revenue ranges from about 1% to about 100%

6. The method of claim 1, wherein the real world currency is a digital or crypto currency.

7. The method of claim 1, wherein the in-game currency is a digital or crypto currency.

8. The method according to claim 1, wherein the game is a video game, non-gambling video game, board game with at least one player.

9. The method of claim 1, wherein the game is an online multiplayer game.

10. The method of claim 1, wherein the game is a massively multiplayer online game.

11. The method of claim 1, wherein the game is an online multiplayer game accessed on a mobile device.

12. The method of claim 1, wherein the game is a multiplayer game accessed on a video game console.

13. The method of claim 1, wherein the game is a social game accessed on a social network.

14. A computer-implemented method based on a gaming system for backing an in-game currency or resource with one or more real world currency or goods, the method comprising:
at least one in-game currency or resource,
providing information to players and other subscribers that the in-game currency or resource is to be backed,
receiving from the game, players or other subscribers revenue associated with the game from one or more of in-game purchases, game subscription fees and in-game advertising,
determining the in-game revenue,
optionally allowing players to redeem all or a portion of the in-game currency or resource,
transferring all or portion of the in-game revenue to a secure location in form of real world currency or goods backing the in-game currency or resource.

15. The method of claim 14, which further comprises determining the unit and total value of the in-game currency or resource from the real world currency or goods in the secure location.

16. The method of claim 14, which optionally comprises allowing players to redeem all or a portion of the in-game currency or resource.

17. The method of claim 14, wherein the transferred portion of in-game revenue ranges from about 1% to about 100%

18. The method of claim 14, wherein the real world currency is a digital or crypto currency.

19. The method of claim 14, wherein the in-game currency is a digital or crypto currency.

20. The method according to claim 14, wherein the game is a video game, non-gambling video game, board game with at least one player.

21. The method of claim 14, wherein the game is an online multiplayer game.

22. The method of claim 14, wherein the game is a massively multiplayer online game.

23. The method of claim 14, wherein the game is a mobile phone or tablet app.

24. The method of claim 14, wherein the game is an online multiplayer game accessed on a mobile device.

25. The method of claim 14, wherein the game is a multiplayer game accessed on a video game console.

26. The method of claim 14, wherein the game is a social game accessed on a social network.
